(19) United States
(12) Patent Application Publication
(10) Pub. No.: US 2020/0290298 A1
(43) Pub. Date: Sep. 17, 2020

(54) METHOD FOR MANUFACTURING SUNGLASS LENSES, AND SUNGLASS LENS

(71) Applicant: XIAMEN JS POLARIZERS TECHNOLOGY CO., LTD, Xiamen, Fujian (CN)

(72) Inventors: Chien-Ming CHAO, Xiamen, Fujian (CN); Chun-Nan LEE, Xiamen, Fujian (CN)

(21) Appl. No.: 16/488,129

(22) PCT Filed: Apr. 25, 2019
(86) PCT No.: PCT/CN2019/084246

§ 371 Date: Aug. 22, 2019

(30) Foreign Application Priority Data
Apr. 27, 2018 (CN) 201810389764.2

(51) Int. Cl. B29D 11/00; G02C 7/10

(52) U.S. Cl. CPC B29D 11/00009; B29K 2105/251; G02C 7/108

(57) ABSTRACT

The invention relates to a method for manufacturing sunglass lenses, and a sunglass lens. The method comprises the following steps: S1, manufacturing of a color powder sheet: a color powder is added to a color powder sheet base material in a corresponding proportion to manufacture a plain color powder sheet; and S2, manufacturing of a lens: the color powder sheet manufactured in S1 is fixed in a cavity of a lens mold, a molten colorless and transparent lens base material is injection-molded in the cavity of the lens mold and is then integrally combined with the color powder sheet in the cavity of the lens mold, and demolding is carried out after cooling, so that a sunglass lens is manufactured. The problem of chromatic aberration of existing sunglass lenses or scratches of films on the existing sunglass lenses is solved.

### BACKGROUND OF THE INVENTION

### 1. Technical Field

The invention relates to the field of manufacturing of optical lenses, in particular to a method for manufacturing sunglass lenses, and a sunglass lens.

### 2. Description of Related Art

Sunglasses, also known as shading glasses, can regulate the intensity and constituents of sunlight by means of lenses to reduce the discomfort and injuries of strong light to the eyes and to protect the eyesight. Sunglass lenses mainly include light-absorption lenses, colored lenses, polarized lenses, and the like.

Existing colored lenses are generally manufactured through the following two methods: as for one method, color powders are directly added to base materials of lenses and are then directly injection-molded to obtain colored lenses, for instance, Chinese Invention Patent Publication No. CN102681212A; as for the other method, a color-powder shading film is plated on lenses by immersion plating to obtain colored lenses, for instance, Chinese Invention Patent Publication No. CN105301797A. However, these two methods have the following defects: the method of directly adding color powders to base materials is suitable for manufacturing plain sunglass lenses, but if this method is used for manufacturing thickness-variable lenses such as myopic sunglass lenses or presbyopic sunglass lenses, the color of these lenses is non-uniform due to the variable thickness of the lenses (the color of the thick area of the lenses is darker than that of the thin area of the lenses), and consequentially, the wear experience is affected; although the thickness of the color-powder film formed on the colored lenses by immersion plating is uniform and the defect of chromatic aberration is overcome, the film may be scratched and fall off due to its small thickness and poor hardness, and consequentially, the light filtering effect of the colored lenses is affected.

### BRIEF SUMMARY OF THE INVENTION

The objective of the invention is to overcome the above defects by providing a method for manufacturing sunglass lenses, and a sunglass lens.

The specific solution is as follows:

A method for manufacturing sunglass lenses comprises the following steps:

S1, manufacturing of a color powder sheet: a color powder is added to a color power sheet base material in a corresponding proportion to manufacture a plain color powder sheet; and

S2, manufacturing of a lens: the color powder sheet manufactured in S1 is fixed in a cavity of a lens mold, a molten colorless and transparent lens base material is injection-molded in the cavity of the lens mold and is integrally combined with the color powder sheet in the cavity of the lens mold, and demolding is carried out after cooling, so that a sunglass lens is manufactured.

Furthermore, the color powder sheet is a circular-arc plain sheet, and the lens base material is injection-molded on the concave surface of the color powder sheet so as to be combined with the color powder sheet.

Furthermore, the color powder sheet manufactured in S1 is a circular-arc plain sheet which is directly formed in a color powder sheet mold provided with a circular-arc cavity, and the color powder sheet has a thickness of 0.3-3.0 mm.

Furthermore, the color powder sheet has a thickness of 0.8-2.5 mm.

Furthermore, the color powder sheet manufactured in S1 is a circular-arc color powder sheet coated with a surface film and formed by injection molding in a photochromic film or polarizing film which is positioned in a color powder sheet mold provided with a circular-arc cavity, and the color powder sheet has a total thickness of 0.5-4.0 mm.

Furthermore, the color powder sheet has a thickness of 1.0-3.0 mm.

Furthermore, the color powder sheet manufactured in S1 is a circular-arc plain sheet which is formed by a flat color powder sheet through a bending process, and the color powder sheet has a thickness of 0.05-1.5 mm.

Furthermore, the color powder sheet has a thickness of 0.1-0.8 mm.

Furthermore, the base material of the color powder sheet is the same as the base material of the lens.

The invention further provides a sunglass lens. The sunglass lens comprises a plain color powder sheet and a transparent lens, wherein the color powder sheet is made from a resin doped with a color powder, and the transparent lens is made from a transparent lens and is combined with the color powder sheet through injection molding.

Furthermore, the color powder sheet is a circular-arc plain sheet, and the transparent lens is injection-molded on the concave surface of the color powder sheet so as to be combined with the color powder sheet.

Furthermore, the outer surface of the color powder sheet is coated with a photochromic film or polarizing film.

Furthermore, the sunglass lens is a myopic lens or a presbyopic lens.

Furthermore, the color powder sheet has a thickness of 0.05-4.0 mm.

Furthermore, the color powder sheet and the transparent lens are made from one resin.

The method for manufacturing sunglass lenses, and the sunglass lens of the invention have the following advantages over the prior art: according to the method for manufacturing sunglass lenses, a plain color powder sheet mixed with a color powder is manufactured first, and then the lens is directly injection-molded in a cavity of a mold to be integrally combined with the color powder sheet, so that the problem of chromatic aberration of existing color powder sheets is solved, and scratches of films plated on existing lenses are avoided.

### BRIEF DESCRIPTION OF THE SEVERAL VIEWS OF THE DRAWINGS

FIG. 1 is a schematic diagram of a sunglass lens in Embodiment 1.

FIG. 2 is a schematic diagram of a sunglass lens in Embodiment 2.

FIG. 3 is a schematic diagram of a sunglass lens in Embodiment 4.

FIG. 4 is a schematic diagram of a sunglass lens in Embodiment 5.

### DETAILED DESCRIPTION OF THE INVENTION

The accompanying drawings are provided for a further explanation of the embodiments of the invention. These accompanying drawings are one part of the contents disclosed by the invention and are mainly used for illustrating the embodiments and explaining the operating principle of the embodiments in cooperation with relevant contents in the specification. By referring to these contents, this ordinarily skilled in the art can appreciate other possible embodiments and advantages of the invention. The components in the drawings are not drawn to scale, and similar reference signs generally represent similar components.

The invention is further explained below in combination with the accompanying drawings and embodiments.

### Embodiment 1

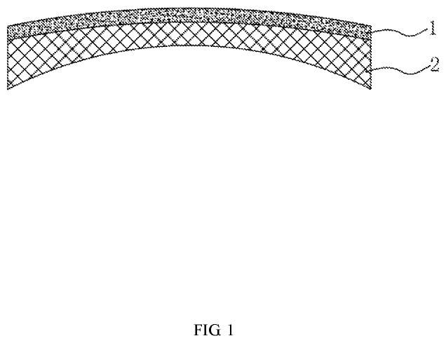

As shown in FIG. 1, this embodiment provides a method for manufacturing sunglass lenses, and a sunglass lens manufactured through the method. The method for manufacturing sunglass lenses comprises the following steps:

S1, manufacturing of a color powder sheet: a color powder is added to a color powder sheet base material (resin), is uniformly mixed, and is then injection-molded in a color powder sheet mold provided with a circular-arc cavity with corresponding curvature, and demolding is carried out after cooling, so that a circular-arc plain color powder sheet 1 is obtained (in this embodiment, the resin is directly injection-molded after being mixed with the color powder; or, the resin mixed with the color powder is prepared into plastic grains containing the color powder first, and then the colored plastic grains are injection-molded; the color powder sheet in the following embodiments can be injection-molded in the same way); the color powder sheet has a thickness of 0.8±0.05 mm, and the resin used as the color powder sheet base material is a synthetic resin such as polymethylmethacrylate (PMMA), dially glycol carbonates (CR-39), polycarbonate (PC), polyamides (PA), or polystyrene (PS). Preferably, the color powder sheet mold is provided with a plurality of locating steps, so that corresponding locating points (these small locating points are not shown) are formed on the color powder sheet 1 manufactured through injection molding to be used for locating in S2.

S2, manufacturing of a lens: the color powder sheet 1 manufactured in S1 is fixed in a cavity of a lens mold through location fit (such as concave-convex fit) between the locating points on the color powder sheet 1 manufactured in S1 and corresponding locating points in the cavity of the lens mold; then a molten colorless and transparent lens base material (resin) is injection-molded in the cavity of the lens mold and is then integrally combined with the color powder sheet 1 in the cavity of the lens mold; and demolding is carried out after cooling, so that a sunglass lens having the transparent lens 2 and the color power sheet 1 integrally combined is manufactured (a myopic lens is illustratively shown), wherein a concave surface with corresponding curvature of the transparent lens 2 is directly formed in the cavity of the lens mode, and the lens base material is a synthetic resin such as PMMA, CR-39, PC, PA, or PS; and preferably, the base material of the transparent lens is the same as the base material of the color powder sheet, so that the binding force between the transparent lens and the color powder sheet is improved.

Due to the fact that the color powder sheet 1 is a plain sheet and has a constant thickness, chromatic aberration of the color powder sheet 1 is avoided; the transparent lens 2 is directly injection-molded on the color powder sheet 1, so that the binding force is good; and in addition, the color powder sheet 1 is much thicker than a film formed by immersion plating, so that the color powder sheet 1 can be normally used even if the color powder sheet 1 is scratched.

Referring to FIG. 1, in this embodiment, the color powder sheet 1 is a circular-arc plain sheet, and the lens base material is injection-molded on the concave surface of the color powder sheet 1 so as to be combined with the color powder sheet 1. Because the base material of the color powder sheet 1 is preferably the same as the base material of the transparent lens 2, the binding force between the color power sheet 1 and the transparent lens 2 is higher after injection molding, stress between the color power sheet 1 and the transparent lens 2 is avoided, and thus, the vision of the lens is better (the rainbow effect caused by the internal stress of the lens is avoided). The base material of the color powder sheet or the lens is a synthetic resin such as PMMA, CR-39, PC, PA, or PS.

The color powder sheet obtained through the method in Embodiment 1 is thick, so that normal usage of the color powder sheet will barely be affected by scratches, abrasion or other damage.

### Embodiment 2

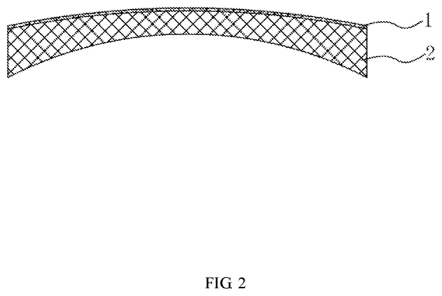

As shown in FIG. 2, this embodiment provides a method for manufacturing sunglass lenses, and a sunglass lens manufactured through the method. The method for manufacturing sunglass lenses comprises the following steps:

S1, manufacturing of a color powder sheet: a color powder is added to a color powder sheet base material (resin), is uniformly mixed, and is then injection-molded in a color powder sheet mold with corresponding curvature, and demolding is carried out after cooling, so that a circular-arc plain color sheet 1 is manufactured, wherein the color powder sheet has a thickness of 0.3±0.05 mm, and the color powder sheet base material in this embodiment is the same as the color powder sheet base material in Embodiment and will not be detailed anymore.

S2, manufacturing of a lens: the color powder sheet 1 manufactured in S1 is fixed in a cavity of a lens mold, wherein because the color powder sheet in this embodiment is thin, the locating steps in Embodiment 1 cannot be formed in S1, and in this case, the color powder sheet 1 is fixed in the cavity of the lens mold with an ejector pin; then a molten colorless and transparent lens base material (resin) is injection-molded in the cavity of the lens mold and is then integrally combined with the color powder sheet 1 in the cavity of the lens mold; and demolding is carried out after cooling, so that a sunglass lens having the transparent lens 2 and the color powder sheet 1 integrally combined is manufactured (a myopic lens is illustratively shown), wherein the transparent lens 2 is a thickness-variable concave lens which is formed by polishing a thick circular-arc plain transparent lens which is manufactured in a unified manner.

What should be pointed out is that the thickness of the color powder sheet 1 obtained through injection molding in S1 should be controlled at least less than the total thickness of the thinnest part of the finally-manufactured sunglass lens (the center of a myopic sunglass lens, and the periphery of a presbyopic sunglass lens), so that all parts of the transparent lens 2 are thick enough and cannot be penetrated when polished.

This embodiment differs from Embodiment 1 in the following aspects: the thickness of the color powder sheet 1 on the outer surface in this embodiment is different from that of the color powder sheet 1 in Embodiment 1; in Embodiment 1, the transparent lens 2 to be combined with the concave surface of the color powder sheet 1 is a concave curved lens which has corresponding curvature and is directly formed in the cavity of the lens mold in S2, while in this embodiment, a thick circular-arc plain transparent lens is manufactured in a unified manner and is then polished to form the thickness-variable transparent concave lens 2; in Embodiment 1, polishing is not needed, but more lens molds are needed for production, while in Embodiment 2, only one lens mold is needed, but subsequent polishing is indispensible.

### Embodiment 3

This embodiment provides a group of different sunglass lenses which are manufactured through the method for manufacturing sunglass lenses in Embodiment 1 or 2. The color powder sheets of the sunglass lenses in this group respectively have a thickness of 1.5±0.05 mm, a thickness of 2.0±0.05 mm, a thickness of 2.5±0.05 mm and a thickness of 3.0±0.05 mm. The color powder sheets of the sunglass lenses in this group are all thicker than the color powder sheet of the sunglass lens in Embodiment 1 and the color powder sheet of the sunglass lens in Embodiment 2, so that under the condition where the same color powder is adopted, the color of the lenses becomes darker gradually to adapt to different occasions.

### Embodiment 4

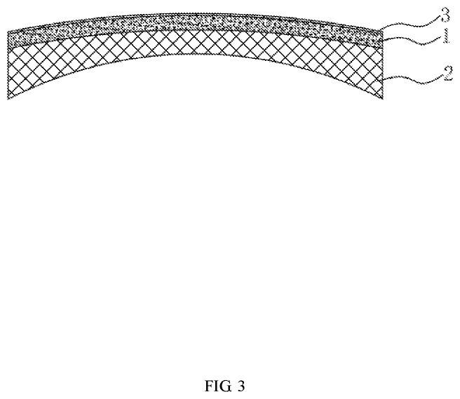

As shown in FIG. 3, this embodiment provides a method for manufacturing sunglass lenses, and a sunglass lens manufactured through the method. The method for manufacturing sunglass lenses comprises the following steps:

S1, a color powder sheet 1 coated with a surface film which is a photochromic film 3 is manufactured;

S11, the photochromic film is fixed in a cavity with corresponding curvature of a color powder sheet mold, wherein the photochromic film has a thickness of 0.2-0.6 mm, and due to the small thickness of the photochromic film, the photochromic film is fixed with an ejector pin;

S12, a molten color powder sheet base material (resin) doped with a color powder in a corresponding proportion is injection-molded in the cavity of the color powder sheet mold and is then integrally combined with the photochromic film in the cavity of the color powder sheet mold (the color powder sheet base material is injection-molded on the concave surface of the photochromic film so as to be combined with the photochromic film), and demolding is carried out after cooling, so that a circular-arc plain color powder sheet 1 coated with the photochromic film 3 is manufactured.

As for this manufacturing method, please see Chinese Invention Patent Publication No. CN201583741U for reference. The total thickness of the composite color powder sheet manufactured through this method is controlled within 1.5-2.0 mm, wherein the color powder sheet base material in this embodiment is the same as that in Embodiment 1 and will not be detailed anymore. Preferably, the color powder sheet mold is provided with a plurality of locating steps, so that corresponding locating points are formed on the color powder sheet 1 obtained through injection molding (these small locating points are not shown) to be used for locating in S2.

S2, manufacturing of a lens: the color powder sheet 1 manufactured in S1 is fixed in a cavity of a lens mold, wherein in this embodiment, the color powder sheet 1 manufactured in S1 is fixed in the cavity of the lens mold through the location fit (such as concave-convex fit) between the locating points formed on the color power sheet 1 in S12 and corresponding locating points in the cavity of the lens mold; then a molten colorless and transparent lens base material (resin) is injection-molded in the cavity of the lens mold and is then integrally combined with the color powder sheet 1 in the cavity of the lens mold (the lens base material is injection-molded on the concave surface of the color powder sheet so as to be combined with the color powder sheet); and demolding is carried out after cooling, so that a sunglass lens having the transparent lens 2 and the color powder sheet 1 integrally combined is manufactured (a myopic lens is illustratively shown), wherein the transparent lens 2 is directly formed as a concave surface with corresponding curvature of in the cavity of the lens mold, so that the influence of subsequent polishing on the photochromic film is avoided (due to the fact that the photochromic film is thin, the photochromic film may be damaged when fixed and positioned during polishing).

The photochromic film is additionally arranged on the color power sheet, so that the sunglass lens can still have a good effect under exceptional circumstances such as outdoor riding, and in this case, the sunglass lens is mainly used for shielding and filtering out ultraviolet rays and generally has a dark color, which means that a dark color powder needs to be added to the color powder sheet; however, users cannot clearly see the road condition when wearing the dark-color sunglass lens in a dim environment. The photochromic film additionally arranged on the color powder sheet can avoid this problem. In the presence of the photochromic film, the color powder sheet can be in a light color, and the sunglass lens can adapt to the environment through the photochromic film while the filtering function is ensured, for instance, a colorless photochromic film can turn dark brown or gray, or a green photochromic film can turn black green.

### Embodiment 5

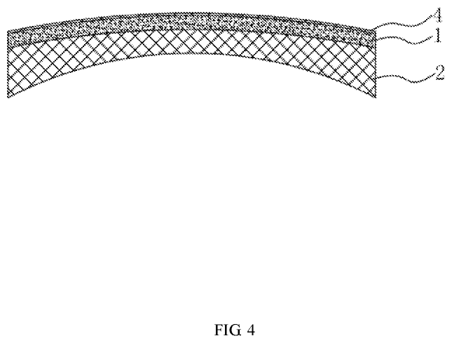

As shown in FIG. 4, this embodiment provides a method for manufacturing sunglass lenses, and a sunglass lens manufactured through the method. The method for manufacturing sunglass lenses comprises the following steps:

S1, a color powder sheet 1 provided with a polarizing film 4 is manufactured;

S11, the polarizing film is fixed in a cavity with corresponding curvature of a color powder sheet mold, wherein the polarizing film have a large thickness of 0.6-1.5 mm and thus can be cut to have a locating shape (not shown) when produced, and locating points are in location fit (concave-convex fit) with corresponding locating points in the cavity of the color power sheet mold;

S12, a molten color power sheet base material (resin) doped with a color powder in a corresponding proportion is injection-molded in the cavity of the color powder sheet mold and is then integrally combined with the polarizing film in the cavity of the color powder sheet mold (the color power sheet base material is injection-molded on the concave surface of the polarizing film so as to be combined with the polarizing film); and demolding is carried out after cooling, so that a circular-arc plain color powder sheet 1 provided with the polarizing film is manufactured.

As for this manufacturing method, please see Chinese Invention Patent Publication No. CN202071290U for reference. The total thickness of the composite color power sheet manufactured through the method is controlled within 2.0-2.5 mm, wherein the color power sheet base material in this embodiment is the same as that in Embodiment 1 and thus will not be detailed anymore. Preferably, the color powder sheet mold is provided with a plurality of locating steps, so that corresponding locating points (these small locating points are not shown) are formed on the color powder sheet 1 obtained through injection molding to be used for locating in S2.

S2, manufacturing of a lens: the color powder sheet 1 manufactured in S1 is fixed in a cavity of a lens mold, wherein in this embodiment, the color powder sheet 1 is fixed in the cavity of the lens mold through the location fit (concave-convex fit) of the locating points formed on the polarizing film 1 in S1 and corresponding locating points in the cavity of the lens mold; then a molten colorless and transparent lens base material (resin) is injection-molded in the cavity of the lens mold and is then integrally combined with the color powder sheet 1 in the cavity of the lens mold (the lens base material is injection-molded on the concave surface of the color powder sheet so as to be combined with the color powder sheet); and demolding is carried out after cooling, so that a sunglass lens having the transparent lens 2 and the color powder sheet 1 integrally combined is manufactured (a myopic lens is illustratively shown), wherein the transparent lens 2 is a thickness-variable transparent concave lens 2 which is formed by polishing a thick circular-arc plain transparent lens manufactured in a unified manner.

The photochromic film is additionally arranged on the color power sheet, so that the sunglass lens can still have a good effect under exceptional circumstances such as outdoor fishing, and in this case, the sunglass lens is mainly used for filtering out ultraviolet rays and is generally in a dark color, which means that a dark color powder is added to the color powder sheet; however, users cannot clearly see the floating condition on water when wearing a dark-color sunglass lens, and glares may be generated by light reflected by water if the sunglass lens is in a light color. The polarizing film is additionally arranged on the color powder sheet to resist strong horizontal light components in dazzling glares, so that the color power sheet can be in a light color.

### Embodiment 6

This embodiment is based on Embodiment 4 and differs from Embodiment 4 in that the photochromic film is replaced with a polarizing film within the same thickness range, and then a color powder sheet having the surface coated with the polarizing film is manufactured in the same way, so that a polarized sunglass lens having a bottom color is manufactured.

### Embodiment 7

This embodiment is based on Embodiment 5 and differs from Embodiment 5 in that the polarizing film is replaced with a photochromic film within the same thickness range, and then a color powder sheet having the surface coated with the photochromic film is manufactured in the same way, so that a photochromic sunglass lens having a bottom color is manufactured.

In conclusion, a sunglass lens provided with a color powder sheet having a thickness of 0.3-3.0 mm can be manufactured through the method in Embodiments 1-3, wherein the thickness of the color powder sheet is preferably 0.5-2.5 mm. A sunglass lens provided with a composite color powder sheet having a thickness of 0.5-4.0 mm can be manufactured by means of an outer film 0.2-1.5 mm (a polarizing film or a photochromic film) through the method in Embodiments 4-7, wherein the thickness of the color powder sheet is preferably 1.0-3.0 mm.

The color powder sheet in Embodiments 1-7 is obtained through injection molding and has a large thickness (0.3-3.0 mm), and thus, it is preferred to directly manufacture a circular-arc plain color powder sheet through injection molding. While, in the case where the color powder sheet is thin, a circular-arc plain color powder sheet can be manufactured in other ways.

### Embodiment 8

This embodiment provides a method for manufacturing sunglass lenses, and a sunglass lens manufactured through the method. The method in this embodiment differs from the method in Embodiment 1 or 2 mainly in the manufacturing process of the color powder sheet. The manufacturing process of the lens in this embodiment is the same as that in Embodiment 1 or 2 and thus will not be detailed anymore. In this embodiment, the color powder sheet is manufactured as follows:

S11, manufacturing of a color powder sheet: a color powder is added to a color powder sheet base material (resin) in a corresponding proportion and is injection-molded in a flat color powder sheet mold after being uniformly mixed, and demolding is carried out after cooling, so that a flat plain color powder sheet is manufactured, wherein the color powder sheet has a thickness of 0.2-0.8 mm (a bendable flexible film), and the color powder sheet base material is a synthetic resin such as PMMA, CR-39, PC, PA, or PS.

S12, bending of the color powder sheet: the film-type color powder sheet 1 is bent through a bending process (such as dry-bending or press-bending), so that a circular-arc color powder sheet 1 with desired curvature is formed.

In this embodiment, a flat plain color powder sheet is manufactured first and is then bent, so that only one mold is needed for injection molding, while the subsequent bending process is needed to obtain color powder sheets with different degrees of curvature. If plain color powder sheets with different degrees of curvature are manufactured at a time through injection molding, the subsequent bending process can be omitted, but multiple molds are needed. The method in this embodiment differs from the method in Embodiment 1 or 2 also in the following aspect: when the color powder sheet exceeds a certain thickness, the flat plain color powder sheet cannot be bent through the bending process anymore.

### Embodiment 9

This embodiment provides a method for manufacturing sunglass lenses, and a sunglass lens manufactured through the method. The method in this embodiment differs from the method in Embodiment 1 or 2 mainly in the manufacturing process of the color powder sheet. The manufacturing process of the lens in this embodiment is the same as that in Embodiment 1 or 2 and thus will not be detailed anymore. The color powder sheet in this embodiment is manufactured as follows:

S11, manufacturing of a color powder sheet: a color powder is added to a color powder sheet base material (resin) in a corresponding proportion, is uniformly mixed and is then extruded in a semi-molten state (the color powder sheet base material is softened, but is not molten) to manufacture a flat plain color powder sheet, wherein the color powder sheet has a thickness of 0.8-1.5 mm, and the base material of the color powder sheet is a synthetic resin such as PMMA, CR-39, PC, PA, or PS.

S12, bending of the color powder sheet: the flat color powder sheet is bent and shaped through a bending process (such as dry-bending or press-bending), so that the circular-arc color powder sheet with required curvature is formed.

### Embodiment 10

This embodiment provides a method for manufacturing sunglass lenses, and a sunglass lens manufactured through the method. The method in this embodiment differs from the method in Embodiment 1 or 2 mainly in the manufacturing process of the color powder sheet. The manufacturing process of the lens in this embodiment is the same as that in Embodiment 1 or 2 and thus will not be detailed anymore. In this embodiment, the color powder sheet is manufactured as follows;

S11, manufacturing of a color powder sheet: a color powder (resin) is added to a color powder sheet base material in a corresponding proportion, is uniformly mixed and is then stretched in one direction in a molten state to directly manufacture a film-type plain color power sheet (color powder film), wherein the color powder sheet has a thickness of 0.1-0.2 mm, and the color powder sheet base material is a synthetic resin such as PMMA, CR-39, PC, PA, or PS.

S12, bending of the color powder sheet: the film-type color powder sheet is placed on a mold with certain curvature to be heated so as to be bent and shaped, so that a circular-arc color powder sheet with required curvature is formed.

Injection molding is not suitable for a color powder sheet with a small thickness, and in this case, the color powder sheet can be manufactured in other ways such as stretching in this embodiment.

### Embodiment 11

This embodiment provides a method for manufacturing sunglass lenses, and a sunglass lens manufactured through the method. The method in this embodiment differs from the method in Embodiment 1 or 2 mainly in the manufacturing process of the color powder sheet. The manufacturing process of the lens in this embodiment is the same as that in Embodiment 1 or 2 and thus will not be detailed anymore. In this embodiment, the color powder sheet is manufactured as follows:

S1, manufacturing of a color powder sheet: a color powder is added to a color powder sheet base material (resin) in a corresponding proportion, is uniformly mixed and is then stretched in two directions in a molten state to directly manufacture a film-type plain color powder sheet (color powder film), wherein the color powder film has a thickness of 0.05-0.1 mm, and the base material of the color powder sheet is a synthetic resin such as PMMA, CR-39, PC, PA, or PS.

Due to the fact that the color powder sheet is very thin and is bendable, the bending process is not needed anymore. When the transparent lens is injection-molded to be combined with the color powder sheet, the color powder sheet (the color powder film) is attached to the cavity with certain curvature.

According to the method in all the above embodiments, and the sunglass lenses manufactured through the method, the color powder sheet 1 is an arc-shaped plain sheet, so that the color is uniform, chromatic aberration is avoided, and the color powder sheet can be used for manufacturing non-plain lenses. Compared with a color powder film formed through immersion plating in the prior art, the color power sheet is much thicker and is better in scratch resistance and abrasion resistance. Compared with existing plain sunglass lenses doped with color powders, consumption of the color powder can be reduced, and the cost of raw materials is reduced.

Although the invention is specifically illustrated and explained above in combination with preferred embodiments, those skilled in the art would appreciate that all changes to the invention in form and in detail achieve without deviating from the spirit and scope defined by the claims should also fall within the protection scope of the invention.

What is claimed is:

1. A method for manufacturing sunglass lenses, comprising the following steps:
S1, manufacturing of a color powder sheet: a color powder is added to a color powder sheet base material in a corresponding proportion to manufacture a plain color powder sheet; and
S2, manufacturing of a lens: the color powder sheet manufactured in S1 is fixed in a cavity of a lens mold, a molten colorless and transparent lens base material is injection-molded in the cavity of the lens mold and is then integrally combined with the color powder sheet in the cavity of the lens mold, and demolding is carried out after cooling, so that a sunglass lens is manufactured.

2. The method for manufacturing sunglass lenses according to claim 1, wherein the color powder sheet is a circular-arc plain sheet, and the lens base material is injection-molded on a concave surface of the color powder sheet so as to be combined with the color powder sheet.

3. The method for manufacturing sunglass lenses according to claim 2, wherein the color powder sheet manufactured in S1 is the circular-arc plain sheet which is directly formed in a color powder sheet mold provided with a circular-arc cavity, and the color powder sheet has a thickness of 0.3-3.0 mm.

4. The method for manufacturing sunglass lenses according to claim 3, wherein the color powder sheet has a thickness of 0.8-2.5 mm.

5. The method for manufacturing sunglass lenses according to claim 2, wherein the color powder sheet manufactured in S1 is the circular-arc color powder sheet coated with a surface film and formed by injection molding in a photochromic film or polarizing film which is positioned in a color powder sheet mold provided with a circular-arc cavity, and the color powder sheet has a total thickness of 0.5-4.0 mm.

6. The method for manufacturing sunglass lenses according to claim 5, wherein the color power sheet has a thickness of 1.0-3.0 mm.

7. The method for manufacturing sunglass lenses according to claim 2, wherein the color power sheet manufactured in S1 is the circular-arc plain sheet which is formed by a flat color power sheet through a bending process, and the color powder sheet has a thickness of 0.05-1.5 mm.

8. The method for manufacturing sunglass lenses according to claim 5, wherein the color power sheet has a thickness of 0.1-0.8 mm.

9. The method for manufacturing sunglass lenses according to claim 1, wherein the base material of the color power sheet is the same as the base material of the lens.

10. A sunglass lens, comprising a plain color powder sheet and a transparent lens, wherein the color powder sheet is made from a resin doped with a color powder, and the transparent lens is made from a transparent resin and is combined with the color powder sheet through injection molding.

11. The sunglass lens according to claim 10, wherein the color powder sheet is a circular-arc plain sheet, and the transparent lens is injection-molded on a concave surface of the color powder sheet so as to be combined with the color powder sheet.

12. The sunglass lens according to claim 10, wherein an outer surface of the color power sheet is coated with a photochromic film or a polarizing film.

13. The sunglass lens according to claim 10, wherein the sunglass lens is a myopic lens or a presbyopic lens.

14. The sunglass lens according to claim 10, wherein the color power sheet has a thickness of 0.05-4.0 mm.

15. The sunglass lens according to claim 10, wherein the color power sheet and the transparent lens are made from one resin.
